(19) United States
(12) Patent Application Publication
(10) Pub. No.: US 2008/0040373 A1
(43) Pub. Date: Feb. 14, 2008

(54) Apparatus and method for implementing match transforms in an enterprise information management system

(75) Inventors: Benjamin Harold Ghamoo-dohth Kuehmichel, La Crosse, WI (US); Ina Loray Mutschelknaus, La Crosse, WI (US)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/503,537

(22) Filed: Aug. 10, 2006

(51) Int. Cl. G06F 7/00

(52) U.S. Cl. 707/101

(57) ABSTRACT

A computer readable medium has executable instructions to present an interface that defines a match transform within a pipeline of data processing operations. Match criteria associated with the match transform is selected. The match criteria is selected from a set of match strategies. The match criteria is used to identify data within an upstream data source that is to be matched by the match transform.

### BRIEF DESCRIPTION OF THE INVENTION

This invention relates generally to digital data processing. More particularly, this invention relates to implementing a match process within an enterprise information management tool.

### BACKGROUND OF THE INVENTION

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information, content delivery infrastructure systems for delivery and management of reports and analytics, data warehousing systems for cleansing and consolidating information from disparate sources, and data management systems, such as relational databases or On Line Analytic Processing (OLAP) systems used to collect, store, and manage raw data.

A subset of business intelligence tools are enterprise information management (EIM) tools. (EIM) tools include functions for maintaining and managing the quality of data. EIM tasks include data integration, data quality/cleansing (i.e., defect detection and correction), and metadata management. Other EIM tasks include data profiling, matching and enrichment. EIM tools are useful for organizations to asses the quality of their data and improve the quality thereof. Traditionally, a large part of EIM has been cleansing of customer data (e.g., names and addresses). EIM can be used for product data and financial data. There are a number of EIM tools for various EIM tasks. Such tools are available from Business Objects, San Jose, Calif.

The EIM task of matching includes identifying, linking, or merging duplicate entries within a set of data or across sets of data. Historically, configuration of an EIM tool to perform a match operation involved programming. The match operation was customized by an end user employing a programming language. A programming language is a set of semantic and syntactic rules to control the behavior of a machine, e.g., a computer. A programming language such as ASP, JSP, Java, .NET, HTML/DHTML, or Python is traditionally employed by the end user to create a match operation.

There are EIM tools with graphical interfaces to design the data flows for EIM data processing. The graphical interface may include a point-and-click interface that sets up a pipeline graphically. A user chooses from a number of predefined transforms, or creates a new transform, and connects the transforms with pipes. The graphical EIM tool is useful for creating pipelines for repetitive tasks. In software engineering, a pipeline consists of a series of pipes and filters (e.g., transforms, processes, or other data processing entities), arranged so that the output of each processes of the chain is the input of the next.

It would be desirable to enhance existing EIM tools to facilitate improved matching operations.

### SUMMARY OF INVENTION

The invention includes a computer readable medium with executable instructions to present an interface that defines a match transform within a pipeline of data processing operations. Match criteria associated with the match transform is selected. The match criteria is selected from a set of match strategies. The match criteria is used to identify data within an upstream data source that is to be matched by the match transform.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates a match transform coupled to other transforms in accordance with an embodiment of the invention.

FIG. 3 illustrates a workflow of a user interacting with a wizard in accordance with an embodiment of the invention.

FIG. 4 illustrates an augmented version of the workflow of FIG. 3 where a multinational match strategy is created in accordance with an embodiment of the invention.

FIG. 5 illustrates the first screen of a wizard where a user selects a match strategy in accordance with an embodiment of the invention.

FIG. 6 illustrates another screen of a wizard where a user selects an input pipe for the match transform in accordance with an embodiment of the invention.

FIG. 7 illustrates another screen of a wizard where a user defines the matching levels for the match transform in accordance with an embodiment of the invention.

FIG. 8 illustrates a screen of a wizard where a user identifies the overlap criteria for a match transform conforming to a strategy of identifying a person in multiple ways and finding the overlap in accordance with an embodiment of the invention.

FIG. 9 illustrates another screen of a wizard where a user defines the match sets in accordance with an embodiment of the invention.

FIG. 10 illustrates another screen of a wizard where a user maps criteria to fields in accordance with an embodiment of the invention.

FIG. 11 illustrates another screen of a wizard where a user creates the break keys for the match transform in accordance with an embodiment of the invention.

FIG. 12 illustrates a completed transform created by a wizard in accordance with an embodiment of the invention.

FIG. 13 illustrates another screen of a wizard where a user selects countries for a multinational matching strategy in accordance with an embodiment of the invention.

FIG. 14 illustrates another screen of a wizard where a user groups countries for a multinational matching strategy in accordance with an embodiment of the invention.

FIG. 15 illustrates a flow chart of the wizard screens shown in FIGS. 5-11 and 13-14 in accordance with an embodiment of the invention.

Like reference numerals refer to corresponding parts throughout the several views of the drawings.

### DETAILED DESCRIPTION OF THE INVENTION

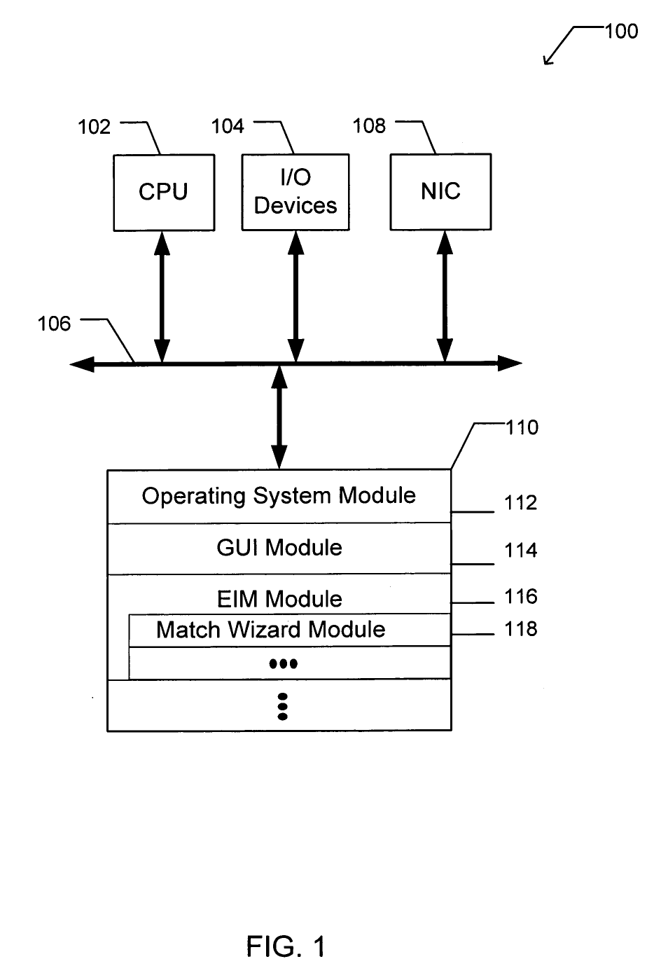

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer and the like. A network interface circuit 108 is also connected to the bus 106. The network interface circuit (NIC) 108 provides connectivity to a network (not shown), thereby allowing the computer 100 to operate in a networked environment.

A memory 110 is also connected to the bus 106. In an embodiment, the memory 110 stores one or more of the following modules: an operating system module 112, a graphical user interface (GUI) module 114, an EIM module 116 and a match wizard module 118.

The operating system module 112 may include instructions for performing hardware dependent tasks or for handling various system services, such as file services. The GUI module 114 may rely upon standard techniques to produce graphical components of a user interface, e.g., windows, icons, buttons, menu and the like, examples of which are discussed below. These standard techniques are used to produce graphical components to support functionality associated with embodiments of the invention, as shown in various examples below.

The EIM module 116 includes executable instructions for maintaining and managing data quality. The executable instructions include instructions to integrate data from different sources, detect defects in data, correct defects in data and manage metadata associated with the data. The match wizard module 118 includes executable instructions to guide a user in establishing a matching transform. The matching transform may be within an EIM pipeline.

The executable modules stored in memory 110 are exemplary. It should be appreciated that the functions of the modules maybe combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

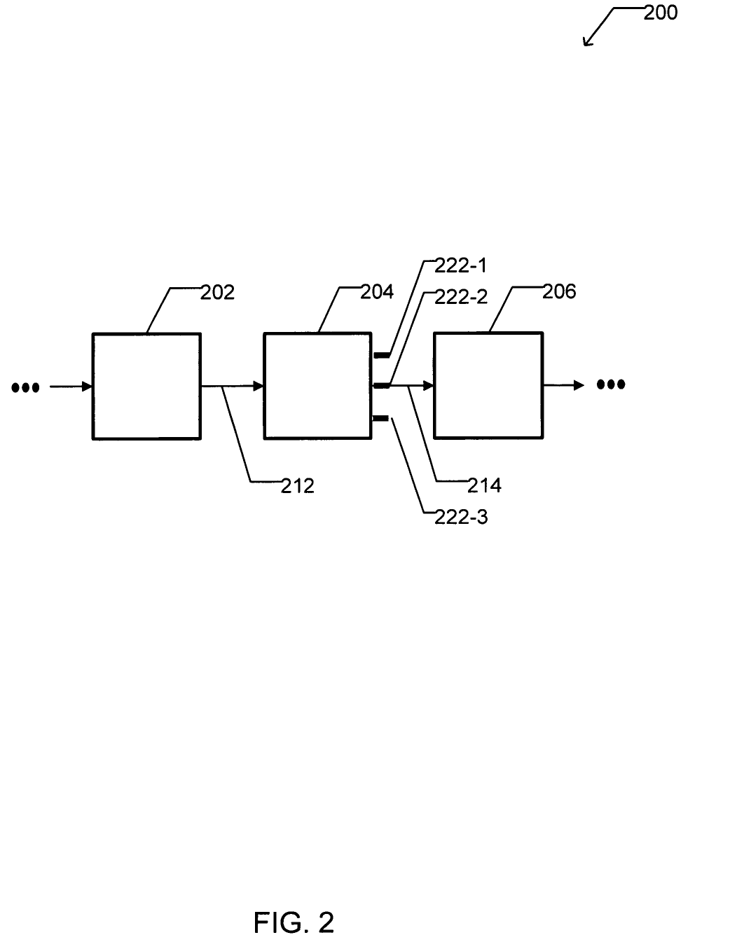

FIG. 2 illustrates a series of coupled transforms in accordance with an embodiment of the invention. These transforms are arranged in accordance with a pipe and filter architecture that is well known in the art. The transforms 202, 204 and 206 implement EIM specific tasks and are coupled by directional pipes 212 and 214. Transform 202 is upstream to match transform 204. In an embodiment, transform 202 is an address cleanse transform, a data cleanse transform, or both.

Match transform 204 implements “matching”. Match transform 204 has a series of output pipes 222-1, 222-2 and 222-3. These output pipes convey the output of the match transform and various intermediate transform stages. In an embodiment, output pipe 222-1 is a pass through pipe conveying the content of pipe 212. Transform 206 is downstream of match transform 204 coupled by pipe 214. In an embodiment, transform 206 is a writer that writes the output of the match transform 204 to a data store.

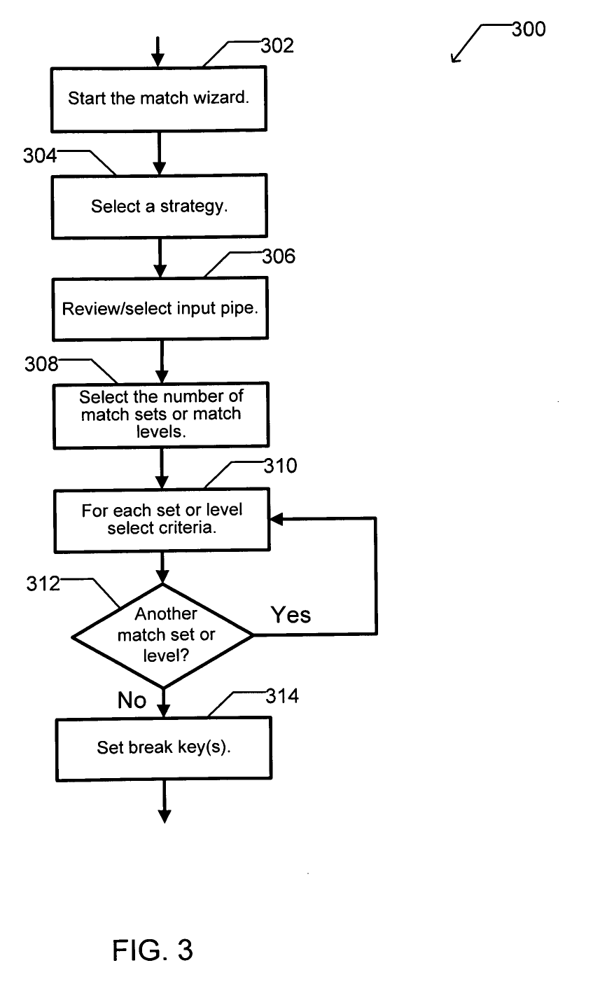

FIG. 3 illustrates a workflow for using a match wizard associated with an embodiment of the invention. The match wizard is launched 302. The match wizard drives workflow 300 by helping the user to configure a match transform. The match wizard allows the user to choose a matching strategy 304. The pipes and filters upstream of the match operation are reviewed or selected 306. Within the chosen strategy, the wizard prompts the user to choose the number of match sets or the number of match levels within a single match set 308. Within each match set or level, the wizard allows the user to choose the criteria on which they wish to base the match 310. This is repeated for each match set and level 312. The wizard allows the user to create a break key 314. The wizard generates the match transform and any ancillary transforms.

In processing operation 302, the user launches the match wizard. The wizard can be launched prior to or after the creation of up- or down-stream transforms. In an embodiment, the wizard is launched from within the GUI of an EIM application.

The user selects a match strategy 304. By selecting a match strategy the match wizard has guidance in building all the necessary parts of the transform (e.g., component transforms). The strategy informs which screens in a wizard are shown, their order and content. In an embodiment, the match strategies presented are at least one of: simple match, consumer house holding, corporate housing holding and multinational match. The simple match is a strategy to create a match transform that matches by groups of names, addresses, or other data and their associations, based on similarities. The consumer house holding strategy match groups individuals, families, or households having similar data. For corporate house holding, the result is a match of groups of individuals having similar data within one company or company site. The multinational match strategy matches groups of names, addresses, or other data and their associations, based on the countries of origin.

In processing operation 306, the user reviews and selects the input pipe for the match transform. For example, the user connects transform 202 to match transform 204 in accordance with FIG. 2. The user can review the upstream transforms and pipes. The user chooses which pipe to connect the match transform. The user chooses the number of match sets or the number of match levels within a single match set 308. For each match set or level, the user chooses the criteria on which they wish to base the match 310. In an embodiment, the use selects multiple criteria. The selection of criteria is repeated for each match set or level 312.

In processing operation 314 the user sets break keys. Break keys define break groups. In matching, data in a break group is compared only to data within the same group and not to data in another break group. The use of break keys is optional, but as at least a quadratic number of comparisons are needed within each group, reducing group size can have a noticeable and important affect on the match transform's performance. A break key is a piece of data that is assumed to be correct. Therefore, the key identifies a group that is assumed to contain distinct data.

In an embodiment, the user connects the output pipes of the match transform to downstream transforms (not shown). In an embodiment, a user can configure the transform to generate source statistics. The transform generates reports as to the data quality of the data source. These reports can be useful for evaluating the data quality of many different data sources, e.g., mailing lists.

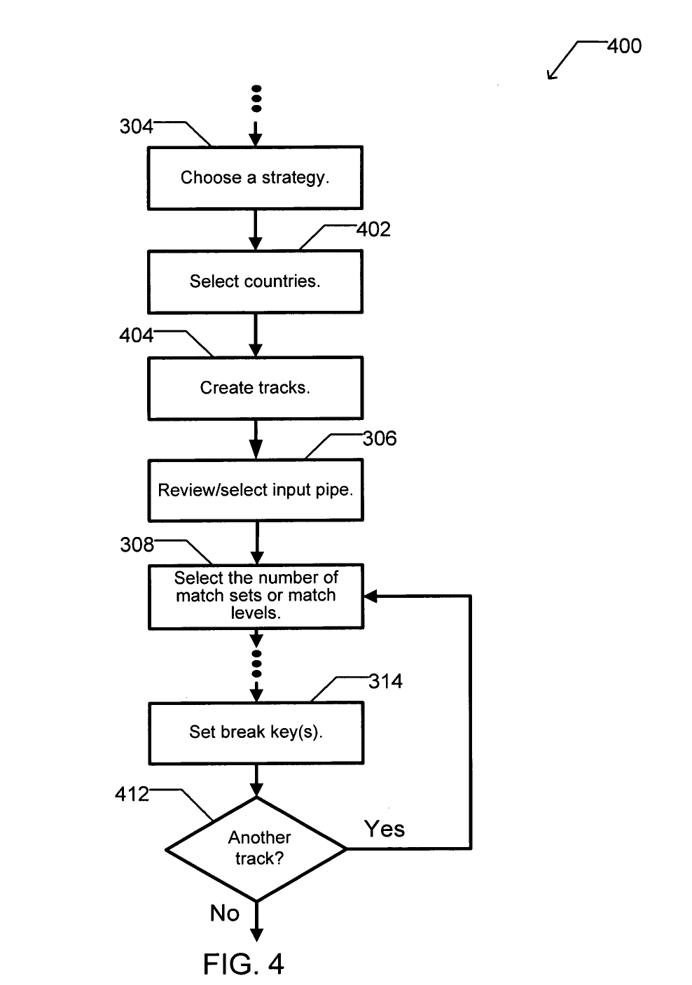

FIG. 4 illustrates a workflow associated with an embodiment of the invention. In workflow 400, operations are inserted into workflow 300 corresponding to the case where the strategy is a multinational match strategy. The user selects the multinational match strategy. Then, in contrast to workflow 300, the user selects countries 402 and creates tracks of countries 404. The tracks of countries are grouping of countries. In an embodiment, these tracks are drawn from different data sources. In an embodiment, these tracks are assigned different match sets within a match transform.

In processing operation 306, the user reviews and selects the input pipe for the match transform. The user chooses the number of match sets or the number of match levels within a single match set 308. The user sets break keys 314. The operations 308 through 314 are repeated for each track created in operation 404. In particular, operation 412 assesses whether additional tracks exist. If so (412-Yes), then processing returns to block 308.

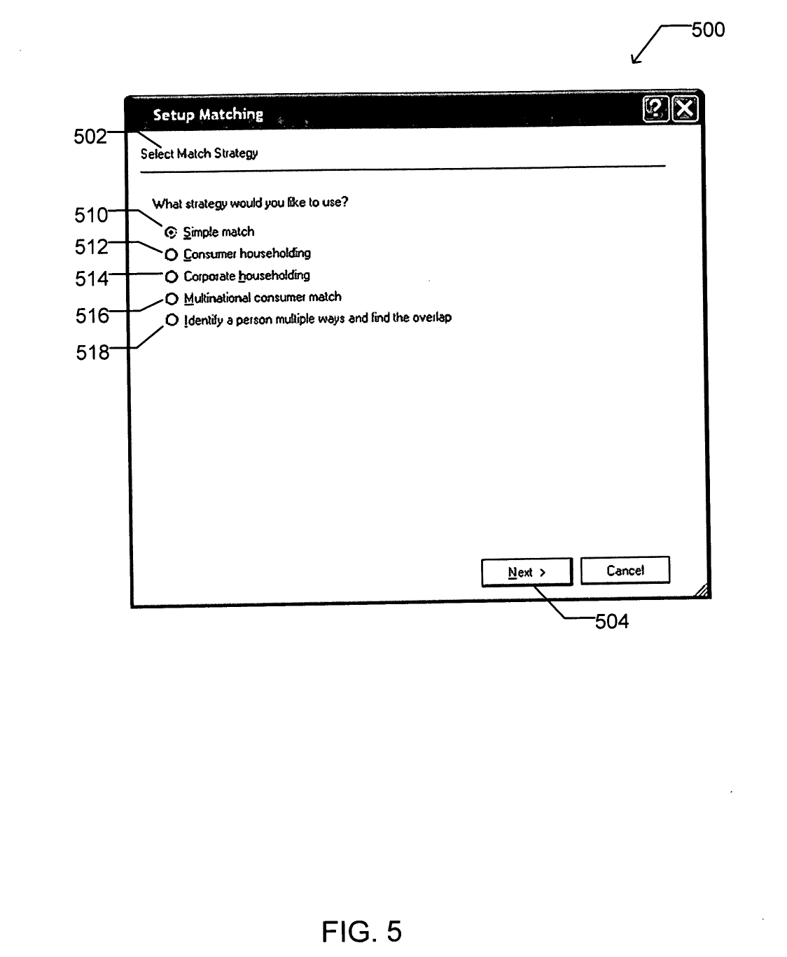

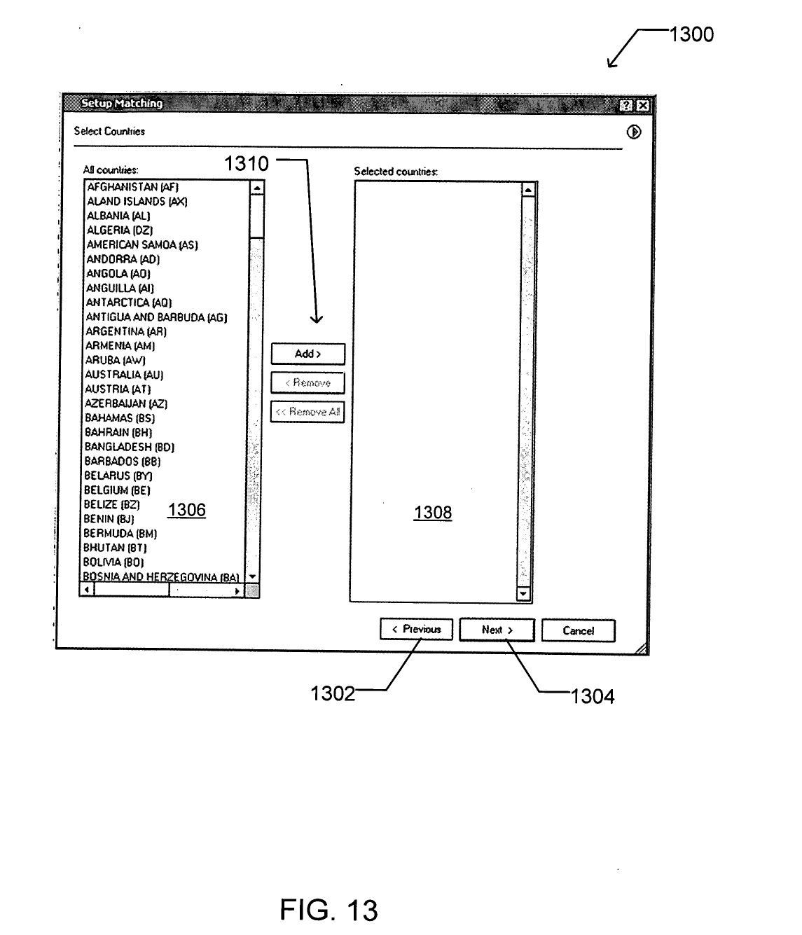

FIG. 5 illustrates the first screen 500 of a wizard utilized in accordance with an embodiment of the invention. The screen 500 can be included in a GUI on computer 100 and generated by executable instructions stored in match wizard module 118. In an embodiment, executable instructions stored in match wizard module 118 collaborate with an EIM application stored in EIM module 116 to create screen 500 and subsequent screens. The screen 500 includes a title 502 stating the purpose of the screen. The purpose of screen 500 is to select a strategy. Various strategies are listed: simple match 510, consumer house holding 512, corporate house holding 514, multinational match 516 and a strategy to identify a person in multiple ways and find the overlap 518. The user selects a strategy via a radio button (e.g., one of radio buttons 510-518). After selecting a strategy, the next button 504 is selected. The result of clicking the next button 504 varies with the selected strategy. When the user selects multinational match 516, the next screen is 1300 shown in FIG. 13. For all other strategies the next screen is the select input pipe screen 600.

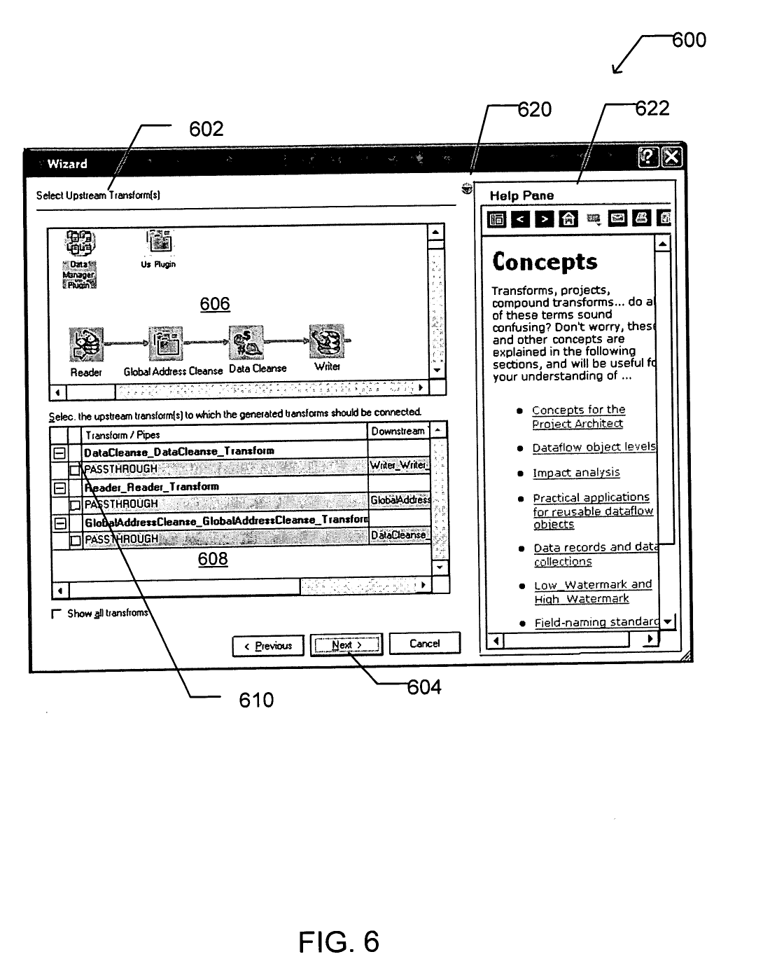

FIG. 6 illustrates the select input pipe screen 600. Per the title 602, screen 600 allows the user to select which transform(s) in the pipeline will be immediately upstream of the match transform. In an embodiment, screen 600 is used to specify which pipe or pipes from the existing transforms will be connected to the match transform. In an embodiment, a graphical representation of the pipeline 606 is included in screen 600. A table 608 is included in screen 600. The table displays names of the transforms in the pipeline. In an embodiment, each reader, address cleanse and data cleanse transform in the pipeline is included in table 608. In FIG. 6, the available output pipe for each transform is displayed in the row immediately below the transform name, e.g., 610. To select an output pipeline, the user checks a check box on a row that contains an output pipe name. The user can be assisted with reference to the graphical representation of the pipeline 606, and the help pane 622 which is toggled with the appear/hide button 620.

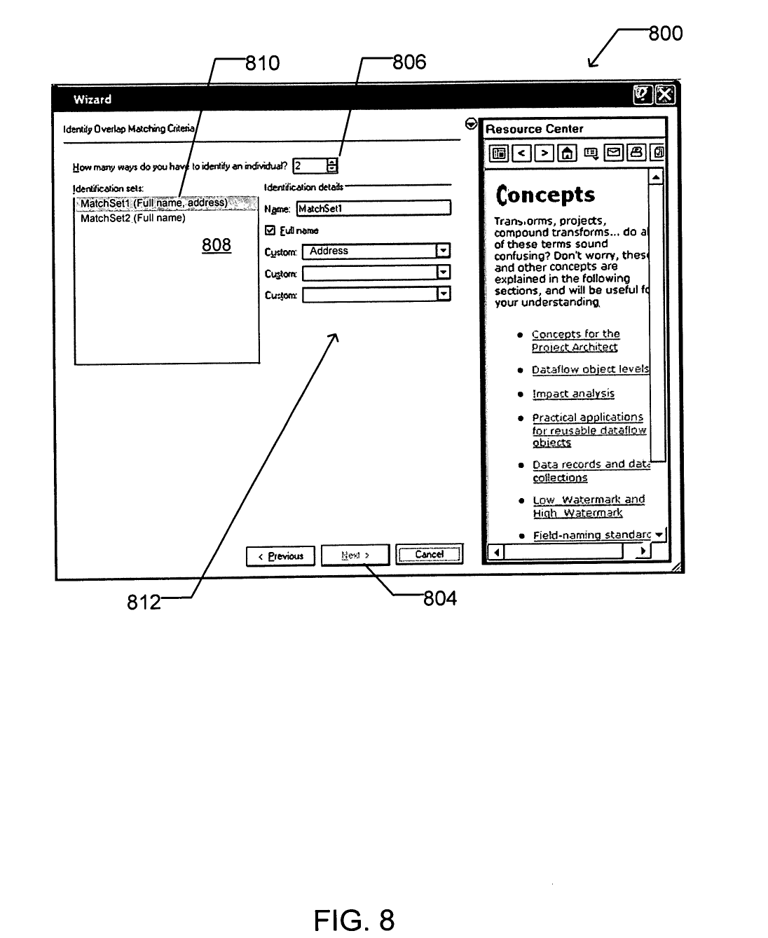

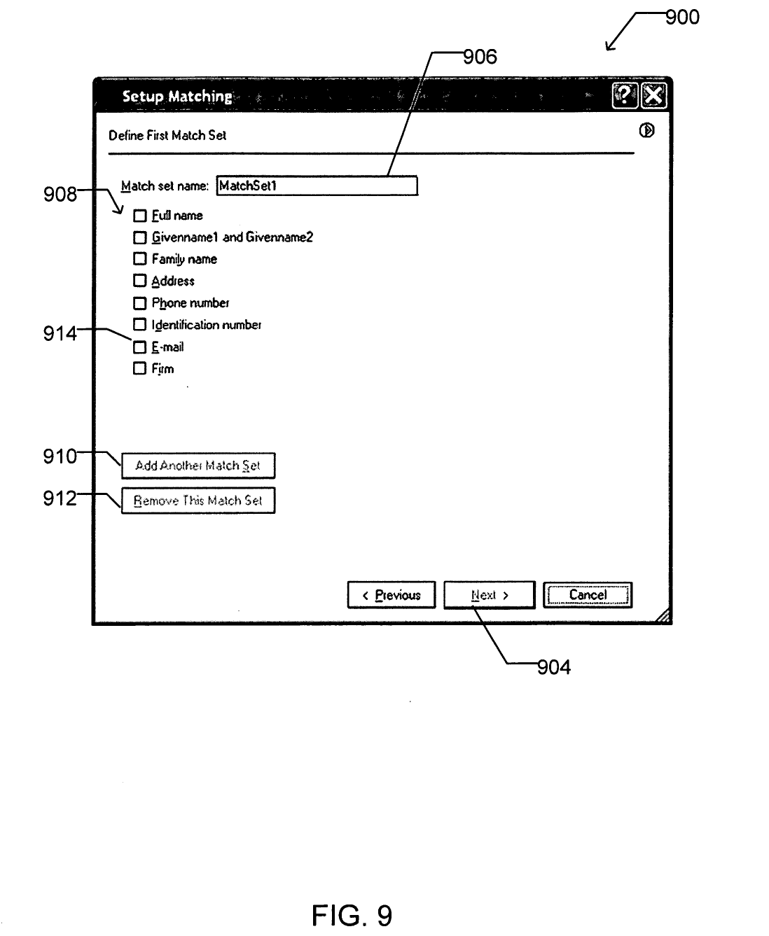

The next button 604 presents the next screen of the wizard to the user. The next screen depends on the selected strategy. If selected strategy is consumer house holding or corporate house holding, the next page will be the define matching levels screen 700. If the selected strategy is a simple match or a multinational match strategy, the next screen is the match sets screen 900 in FIG. 9. If the selected strategy is “Identify a person multiple ways and find the overlap”, then the next screen will be the identify overlap screen 800 in FIG. 8.

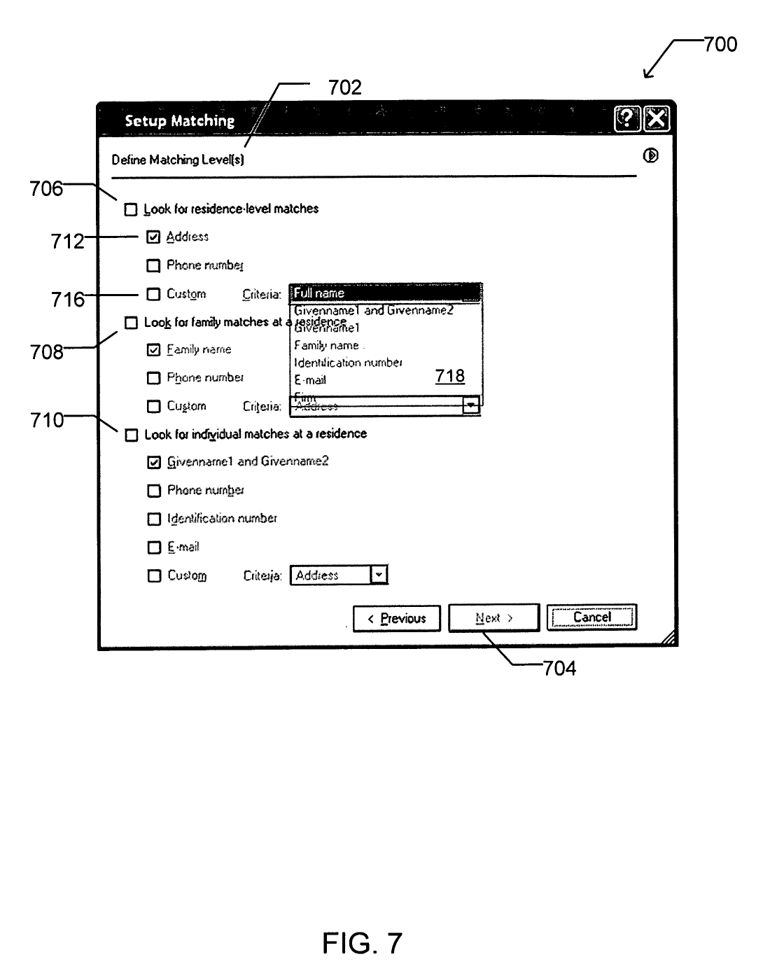

FIG. 7 illustrates the define matching levels screen 700. Per the title 702, screen 700 allows the user to select levels in a hierarchical match, with appropriate criteria for each level. In an embodiment, screen 700 presents the user with a choice of one to three levels (i.e., 706, 708 and 710) in the hierarchical match. In an embodiment, the first level is “look for residence-level match”; the second level is “look for family matches a residence”; and the third level is “look for individual matches at a residence”. The match levels 706, 708 and 710 can be selected by the user. In an embodiment, each match level will have a default criterion, e.g., “Address” 712 for first level 702. The user may add additional criteria by selecting the appropriate check boxes under any selected match level. If a user selects the custom checkbox 716, a corresponding list box 718 is enabled. In an embodiment, the contents of the list box 718 is full name, given name, family name, identification number, email, and firm. In an embodiment, the default custom criteria for the first level 706 is full name and address for the other levels. In an embodiment, if the criteria selected in the combo box is the same as another criterion already selected in that match level, the duplicate criterion is ignored. In another embodiment, the user is alerted to the duplication.

In an embodiment, if the selected strategy is corporate house holding Define Matching Levels is similar to screen 700. In an embodiment, the first level is “look for corporate-level match”; the second level is “look for site matches a corporation”; and the third level is “look for individual matches at a corporation”.

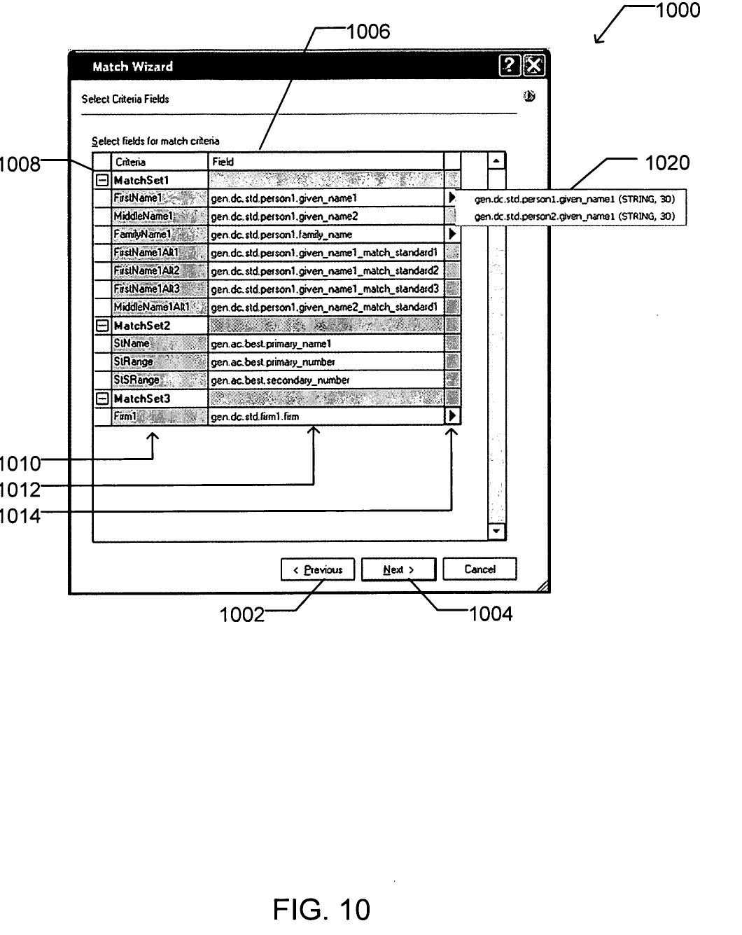

When the user adds at least one match level, the next button 704 is enabled. The next button 704 takes the user to the select criteria fields screen 1000 in FIG. 10.

FIG. 8 illustrates the Identify Overlap screen 800. Screen 800 follows screen 600 when the user selects “Identify a person multiple ways and find the overlap” strategy in screen 500. Screen 800 allows the user to select the number of match sets to be created and to select the criteria to be used in each match set. Each match set specifies a different way to identify an individual. In an embodiment, a spin box 806 allows a user to specify the number of ways to identify an individual. In an embodiment, two through eight ways are permitted. When the value of this spin box is changed, an equivalent number of entries is placed in the match sets list box 808. The match sets list box 808 allows the user to select a match set to which criteria are added. Each entry contains the name of a match set, as well as the currently selected criteria for that match set in parentheses, e.g., 810. When the user selects an entry in the match sets list box 808, the values in the controls of the Identification Details group 812 changes to display the data for the currently selected match set. The next button 804 is enabled when all match sets have at least one criteria. The next button 804 takes the user to the select criteria fields screen 1000 in FIG. 10.

FIG. 9 illustrates the define match set screen 900. Screen 900 follows screen 600 when the user selects either the simple match or multinational match strategy in screen 500. Screen 900 allows the user to add criteria to a match set by selecting the desired check boxes 908. In an embodiment, screen 900 allows the user to add and remove match sets using buttons 910 and 912. In an embodiment, each match set has the same criteria choices. In an embodiment, the wizard warns the user if two or more match sets have the same criteria. The number of match sets a user can create varies with embodiments of the present invention.

Screen 900 allows the user to add criteria to a match set by selecting the desired check boxes 908. In an embodiment, any invalid check boxes are not presented or are grayed out. Computer 100 determines that a check box is invalid by looking upstream to the data source. If the data source does not have the fields for the criteria, the associated box is grayed out.

The next button 904 is enabled when all remaining match sets have at least one criterion. The next button 904 takes the user to the select criteria fields screen 1000 in FIG. 10.

FIG. 10 illustrates screen 1000 wherein a user maps criteria to fields in accordance with an embodiment of the invention. Screen 1000 displays the default input field for each criterion in each match transform and allows the user to change the selected input field. Included in screen 1000 is a table 1006. The first column of the table 1006 includes an expand/collapse icon for each row that contains the name of a match set or match level 1008. The user can expand and hide the criteria of a level using this icon. A criteria column 1010 includes the name of the match set or level or the name of a single criterion. The table 1006 includes a field column 1012 which includes the name of an output field from an upstream transform that is used as the input field for the criterion on the same row.

In an embodiment, each criterion has a field name (shown) and a content type (not shown) associated with it. The content type is used to do a reverse field mapping. That is, if a single field of that content type is available upstream, that field becomes the used upstream field. If multiple fields of that content type are available upstream, the user can select which upstream fields to match to the specified content type. In an embodiment, selecting between upstream fields is accomplished by flyout menu, e.g., 1020. The menu can be activated by an icon in the fourth column 1014. In an embodiment, if there are no alternative upstream fields no menu is provided. When selected, a given output field in the menu replaces the current field in the field column of the present row. In an embodiment, the user manually edits the field cell in the field column.

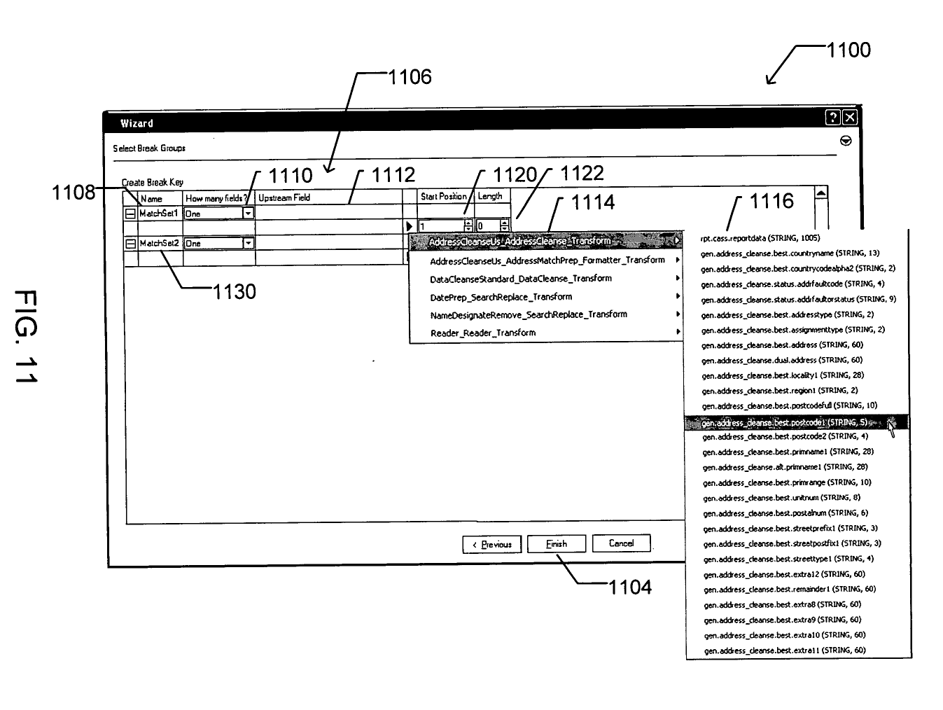

The previous button 1002 takes the user to the previous screen, which depends on the strategy selected by the user. Previous screens include the define matching levels screen 700, the identify overlap screen 800 and define match set screen 900. The next button 1004 takes the user to the select break groups screen 1100 in FIG. 11.

FIG. 11 illustrates select break groups screen 1100 where a user creates the break keys for the match transform. Break keys define break groups. A break key is a piece of data that is assumed to be correct. Screen 1100 includes a table 1106 which includes the various match sets, e.g., MatchSet1 1108. In an embodiment, for each match set, the user can select a number of break keys via a combo box, e.g., 1110. The break keys are upstream fields displayed in a column of the table 1112. The user can select the fields (break keys) via a menu to each upstream transform 1114 and a menu of output fields from those transforms 1116.

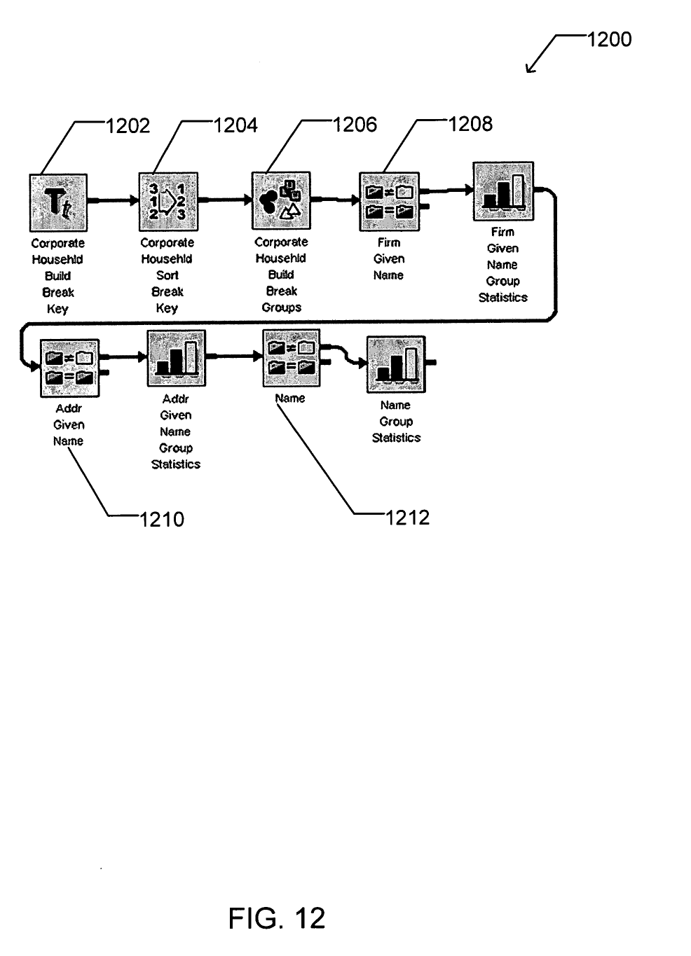

In an embodiment, the user can select which parts of an upstream field to serve as a break key. For example, first and last letter in a name, the first character in a postal code, and entire name of state, province or region could serve as a break key. In an embodiment, the user can select the starting character and length of the break key by spin boxes 1120 and 1122. The user can repeat the procedure for another match set 1130. The next button 1104 takes the user to the completed transform 1200 in FIG. 12.

FIG. 12 illustrates a completed transform 1200 created by a wizard in accordance with an embodiment of the invention. FIG. 12 shows an example of a match transform conforming to a corporate house holding strategy. The transform 1200 has several components. The workflow of the wizard differs from the order of components in the transform. The transform begins by identifying breaks keys 1202. Then the break keys are sorted 1204. The break groups defined by these break keys are created 1206. These three components of transform 1200 were created by wizard screen 1100. The transform continues at a component to match on firm name 1208. This is piped to a match by address 1210 and a match by name 1212. Each match component is generated by screens 700 and 1000.

How examples of transforms like transform 1200 are created when the wizard is complete differ with the strategy chosen by the user. If the strategy is a house holding strategy, the process is create break group component and create a match component for each level specified in the wizard. These components are connected and combined in a match transform. If the strategy is a simple match, then for each match set, executable instructions stored in the match wizard module 118 create a break group component and match component. In an embodiment, there is one break group for the data source, i.e., no break key. These components are connected and combined in a match transform by connecting match sets together downstream of the break groups.

FIG. 13 illustrates a screen 1300 of a wizard where a user selects countries for a multinational matching strategy in accordance with an embodiment of the invention. The user selects countries from a list 1306 and transfers them to a second list 1308. In an embodiment, the list 1306 includes the supported countries of the EIM application stored in EIM module 116. The user transfers the countries between list 1306 and 1308 by controls 1310. The previous button 1302 takes the user to the select strategy screen 500. The next button 1304 takes the user to the create tracks screen 1400.

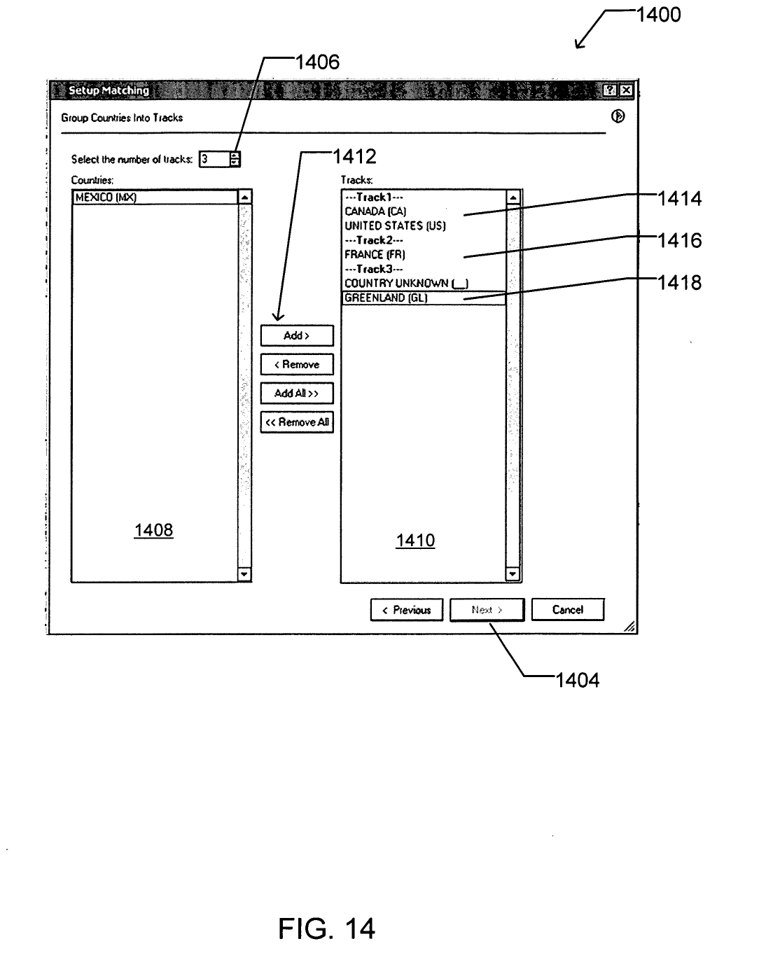

FIG. 14 illustrates create tracks screen 1400 screen of a wizard where a user groups countries for a multinational matching strategy in accordance with an embodiment of the invention. The countries selected in screen 1300 of FIG. 13 are grouped into tracks. In an embodiment, these tracks are processed in parallel match sets in the match transform. The countries within each track can share matching rules. For example, tracks based on language of country can be created. In an embodiment, countries are replaced in screens 1300 and 1400 with regions that are bigger or smaller than countries. The user can select how many tracks to create with spin box 1406. The countries from list 1408, selected on screen 1300, are added to the select track in list 1410 with controls 1412. There are three tracks shown in screen 1400: 1414, 1416 and 1418. The selected track is 1418. There is an additional entry called “COUNTRY UNKNOWN” to handle omissions in the data source. The next button 1404 takes the user to the next screen, which is the select input pipe screen 600 in FIG. 6.

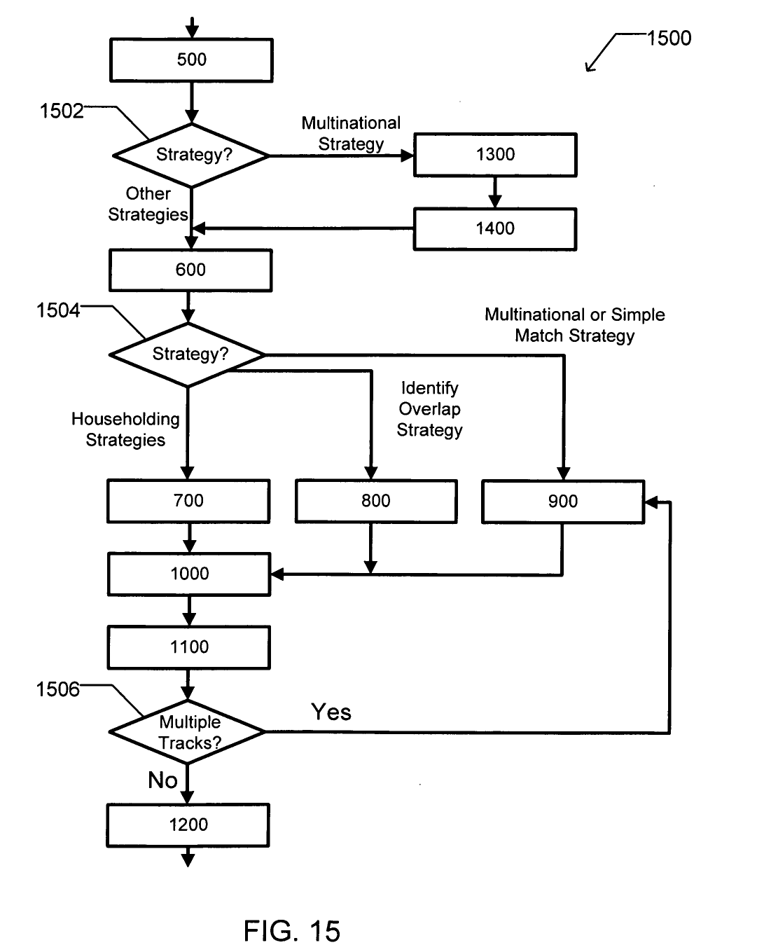

FIG. 15 illustrates a flow chart 1500 of the wizard screens shown in FIGS. 5-11 and 13-14. The presentation of the various screens depends on the strategy selected in screen 500. At decision 1502, the flow branches to the screen 1300 when the strategy is a multi national match strategy. The user selects the countries for the multinational map in screen 1300 and groups them into tracks in screen 1400. If Other Strategies are selected at decision block 1502, the next screen is the select input pipes 600. At decision block 1504, the strategy is again tested by computer 100. If House holding Strategies, e.g., corporate or residential house holding is selected in screen 500, the next screen is the define matching levels screen 700. If Identify Overlap Strategy is selected, the next screen is the identify overlap screen 800. If a Multinational or Simple Match Strategy is selected, the next screen is the match set screen 900.

The next screen after screen 700, 800 and 900 is the screen 1000 where the users maps the match criteria to upstream fields. After screen 1000 is screen 1100, where the user sets break keys. At decision block 1506, the wizard may iterate if the current strategy is a multinational match strategy, and there are tracks of countries without match sets determined. If there is a Yes decision at block 1506, there are remaining tracks that need to be defined so the next screen is 900. If there is a No decision at block 1506, the wizard completes.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium, comprising executable instructions to:
present an interface to define a match transform within a pipeline of data processing operations;
select match criteria associated with the match transform, wherein the match criteria is selected from a plurality of match strategies; and
use the match criteria to identify data within an upstream data source that is to be matched by the match transform.

2. The computer readable medium of claim 1 wherein the executable instructions to select include executable instructions to select match criteria from match strategies including at least two of: a simple match strategy, a consumer house holding match strategy, a corporate house holding match strategy, and a multinational consumer match strategy.

3. The computer readable medium of claim 1 wherein the executable instructions to select include executable instructions to select match criteria that defines match levels.

4. The computer readable medium of claim 3 further comprising executable instructions to define match levels from residence level matches, family matches at a residence, and individual matches at a residence.

5. The computer readable medium of claim 3 further comprising executable instructions to define match levels from corporation level matches, site matches within a corporation and individual matches at a corporation.

6. The computer readable medium of claim 3 further comprising executable instructions to establish criteria for each match level.

7. The computer readable medium of claim 1 wherein the executable instructions to select include executable instructions to select match criteria specifying overlapping matching criteria.

8. The computer readable medium of claim 1 wherein the executable instructions to establish a pipeline of data processing operations includes executable instructions to specify at least one data transform prior to said match transform and at least one data transform after said match transform.

9. The computer readable medium of claim 1 further comprising executable instructions to present a plurality of data processing strategies to a user.

10. The computer readable medium of claim 1 further comprising executable instructions to process a break key.

11. The computer readable medium of claim 1 further comprising executable instructions to establish match criteria based on available data in the upstream data source.

12. The computer readable medium of claim 1 further comprising executable instructions to retrieve a data description for one or more fields in the upstream data source.

13. The computer readable medium of claim 1 wherein the executable instructions to select include executable instructions to select match criteria that defines a plurality of match sets.

14. The computer readable medium of claim 13 further comprising executable instructions to establish criteria for each match set in the plurality of match sets.

15. The computer readable medium of claim 13 wherein a match set in the plurality of match sets is a track including a country.
